(19) United States
(12) Patent Application Publication
(10) Pub. No.: US 2025/0235372 A1
(43) Pub. Date: Jul. 24, 2025

(54) VEHICLE SEAT WITH HEADREST HAVING MASSAGE DEVICE

(71) Applicants: Hyundai Motor Company, Seoul (KR); Kia Corporation, Seoul (KR); Hyundai Transys Inc., Seosan (KR)

(72) Inventors: Tae Hee Won, Uiwang (KR); In Gyu Jang, Hwaseong (KR); Tae Yeon Lee, Hwaseong (KR)

(21) Appl. No.: 18/752,158

(22) Filed: Jun. 24, 2024

(30) Foreign Application Priority Data
Jan. 24, 2024 (KR) 10-2024-0010890

(51) Int. Cl. A61H 9/00; B60N 2/809; B60N 2/90

(52) U.S. Cl. CPC A61H 9/0078; B60N 2/809; B60N 2/976; A61H 2201/0149; A61H 2201/0196; A61H 2205/04

(57) ABSTRACT

A seat for a vehicle includes: an input device for receiving input information including height information of a passenger, a backrest unit configured to support a back of the passenger; and a headrest disposed above the backrest unit, such that in the headrest, a massage device is disposed at a position depending on the height information of the passage for massaging a portion of a body of the passenger.

### CROSS-REFERENCE TO RELATED APPLICATION(S)

This application claims under 35 U.S.C. § 119 (a) the benefit of Korean Patent Application No. 10-2024-0010890 filed on Jan. 24, 2024 in the Korean Intellectual Property Office, the entire contents of which are incorporated herein by reference.

### BACKGROUND

### (a) Technical Field

The present disclosure relates to a seat for a vehicle, more particularly, to the seat in which a headrest includes a massage device that is positioned based on a height of a passenger.

### (b) Description of the Related Art

A seat for a vehicle is designed to accommodate an occupant including a driver and/or passenger. The seat typically includes a seating unit on which the occupant sits, a backrest unit supporting a back of the occupant and a headrest supporting a head of the occupant.

Because the seat is in close contact with the occupant, the seat is manufactured so that the seated occupant may feel comfortable.

Recently, various functions are included in the seat. For example, a massage device for reducing fatigue of the occupant may be applied to the seat.

It is effective to relax the occupant's neck muscles in order to reduce the fatigue of the occupant. Since the headrest is usually designed to be in contact with the occupant's head, even if the massage device is disposed in the headrest, it may be difficult to effectively massage the passenger's neck muscles therewith.

### SUMMARY

To solve at least some of the aforementioned problems, an aspect of the present disclosure is to provide a seat configured to effectively massage a passenger's neck muscles in a seat equipped with a massage device on a headrest.

According to an aspect of the present disclosure to achieve the aforementioned purpose, a seat for a vehicle includes: an input device configured to receive input information including height information of a passenger; a backrest unit configured to support a back of the passenger; and a headrest disposed above the backrest unit, wherein in the headrest, a massage device configured to massage a portion of a body of the passenger is disposed, and a position of the massage device changes depending on the height information of the passenger input to the input device.

The headrest includes: a body portion; and a support portion disposed in front of the body portion and slidingly moving in a vertical direction of the body portion along the body portion, and the massage device is disposed in the support portion.

The body portion is provided to be movable in a vertical direction of the backrest unit.

The support portion is moved to an uppermost portion moved to the maximum in an upper direction of the body portion, a lowermost portion moved to the maximum in a downward direction of the body portion, or a middle portion disposed between the uppermost portion and the lowermost portion, according to the height information of the passenger.

The body portion is moved to an uppermost portion moved to the maximum in an upward direction of the backrest unit, a lowermost portion moved to the maximum in a downward direction of the backrest unit, or a middle portion disposed between the uppermost portion and the lowermost portion.

The massage device includes: first to third air cells disposed on the headrest, and the first air cell is disposed between the second air cell and the third air cell.

The headrest includes: a center portion; a first wing out disposed on one side of the center portion; and a second wing out disposed on the other side of the center portion, wherein the first air cell is disposed in the center portion, the second air cell is disposed in the first wing out, and the third air cell is disposed in the second wing out.

The input device is provided to enable the passenger to select a first massage mode, and the first massage mode includes an operation of expanding or contracting the second air cell and the third air cell.

The input device is provided to enable the passenger to select a second massage mode, and the second massage mode includes an operation of expanding or contracting the first air cell.

The input device is provided to enable the passenger to select a third massage mode, and the third massage mode includes an operation of expanding or contracting the first air cell, the second air cell, and the third air cell.

A vehicle may include the above-described seat.

Additionally, a seat includes: a seating unit on which the passenger is seated; a backrest unit configured to support a back of a passenger; a headrest disposed above the backrest unit; and a massage device disposed in the headrest, where the headrest is configured to change position depending on height information of the passenger.

A position of the headrest changes depending on height information of the passenger.

The headrest includes: a body portion; and a support portion disposed in front of the body portion and slidingly moving in a vertical direction of the body portion along the body portion.

The massage device is disposed on the support portion.

A seat according to an example embodiment of the present disclosure has an effect of reducing fatigue of a passenger by effectively massaging neck muscles of the passenger.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a conceptual diagram illustrating a seat operating by electricity;

FIG. 2 is a view illustrating an operation of a headrest disposed on a seat according to an example embodiment of the present disclosure;

FIG. 3 is a front view of a headrest according to an example embodiment of the present disclosure;

FIG. 4 is a view illustrating a headrest according to an example embodiment of the present disclosure after removing an outer shell thereof;

FIG. 5 is a flowchart illustrating an operation of a massage device according to an example embodiment of the present disclosure;

FIGS. 6 to 11 are views illustrating input information and input menus provided through a display of an input device according to an example embodiment of the present disclosure;

FIG. 12 is a view illustrating a position of a headrest according to body information of a passenger; and

FIG. 13 is a view illustrating an operation of an air cell according to a massage mode.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, the present disclosure may make various changes and have various embodiments, specific embodiments thereof will be described and illustrated in the drawings. However, the embodiments are not intended for limiting the invention. The idea of the present disclosure should be construed to extend to any alterations, equivalents and substitutes besides the accompanying drawings.

It will be understood that although the terms first, second, etc., may be used herein to describe various elements, these elements should not be limited by these terms. These terms are generally only used to distinguish one element from another. For example, a first element could be termed a second element, and, similarly, a second element could be termed a first element, without departing from the scope of the present disclosure. The term of and/or encompasses a combination of plural items or any one of the plural items.

Unless otherwise defined, all terms including technical and scientific terms used herein have the same meaning as commonly understood by one of ordinary skill in the art to which example embodiments of the present disclosure belong. It will be further understood that the terms, such as those defined in commonly used dictionaries, should be interpreted as having meanings that are consistent with their meanings in the context of the relevant art and will not be interpreted in an idealized or overly formal sense unless expressly so defined herein.

In the present disclosure, the vehicle refers to various vehicles for moving transported objects such as people or animals, things, and the like, from a departure point to a destination. Such vehicles are not limited to vehicles driving on roads or tracks. Additionally, vehicles not only use fossil fuels such as gasoline and gasoline, but also include those using secondary batteries that use electricity stored in batteries, etc., and those that use future fuels such as hydrogen.

Terms used in relation to directions in the description below, such as “front,” “rear,” “side,” “forward,” “backward,” “up and down,” “up,” “upper,” “upper portion,” “bottom,” “lower,” “lower portion,” “left and right,” and the like, are explanations based on passengers seated on a seat. Specifically, the front may refer to a fronts side based on the passenger, and the rear may refer to a rear side based on the passenger. Additionally, a case of meaning indicating upper and lower sides is based on a case in which a back of the passenger seated on the seat is in contact with a backrest, and the passenger's head may refer to the upper side, and the passenger's waist may refer to the lower side.

Furthermore, the terms such as “first” or “second” may be used to describe various elements, but these elements are not limited in order, size, position, and importance by terms such as “first” and “second” and may be used for distinguishing one component from other components.

Hereinafter, embodiments of the present disclosure will be described with reference to the attached drawings.

A seat 1 according to the present disclosure may be operated by electricity. In other words, the seat may be operated by electricity through a driving device such as a motor. Accordingly, the power required for an operation of the seat 1 may be provided to the driving device of the seat 1 through a power supply device provided in a transportation vehicle. An example of the drive device may include a motor.

The transportation vehicle may be equipped with an input device for driving the seat 1. A passenger may input a command for driving the seat 1 using the input device. In this case, the input device may be disposed on a portion of the seat 1. However, the input device may be disposed independently from the seat 1 inside the vehicle. The input device may be, for example, a physical button, and as another example, the input device may be an input device including a touchscreen.

When the command of the passenger is input through the input device, a controller may control an operation of the seat 1 and a massage device based on the input command.

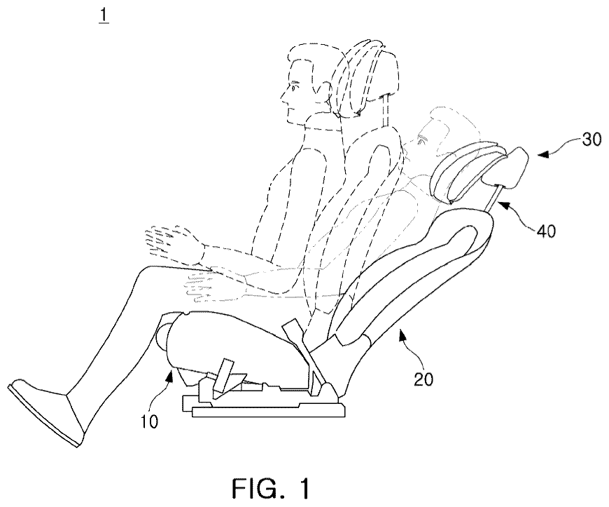

FIG. 1 is a conceptual diagram illustrating a seat operating by electricity.

Referring to FIG. 1, a seat 1 may include a seating unit 10, a backrest unit 20 disposed behind the seating unit 10, and a headrest 30 disposed above the backrest unit 20. In this case, the headrest 30 may be connected to the backrest unit 20 through a stay 40.

The seating unit 10 may move forwards, backwards, upwards, or downwards. The seating unit 10 may be moved by an electric motor.

The backrest unit 20 may be hingedly coupled to the seating unit 10. Accordingly, the backrest unit 20 may rotate in a predetermined angle range with a rear portion of the seating unit 10 as a center of rotation. That is, the backrest unit 20 may perform a tilt operation with a lower portion of the backrest unit 20 as the center of rotation. The backrest unit 20 may be rotated by an electric motor.

The headrest 30 may be coupled to the backrest unit 20 by the stay 40. A portion of the stay 40 may be inserted into an upper portion of the backrest unit 20. Depending on an insertion depth of the stay 40, an appropriate position of the headrest 30 may be adjusted.

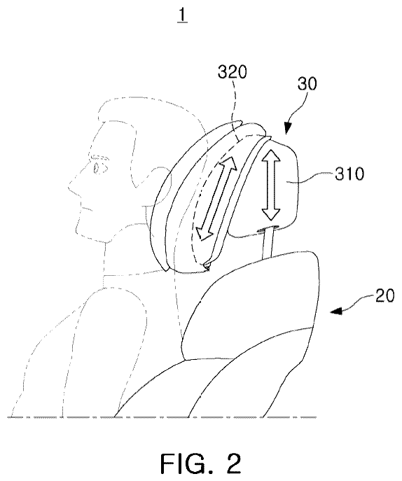

FIG. 2 is a view illustrating an operation of a headrest disposed on a seat according to an example embodiment of the present disclosure.

The headrest 30 may be coupled to the stay 40. A portion of the stay 40 may be disposed in the headrest 30.

The headrest 30 may include a body portion 310 and a support portion 320. The body portion 310 may be a portion coupled to the stay, and the support portion 320 may be disposed in front of the body portion 310 and may be a portion that a head of the passenger comes into contact with.

The body portion 310 may move up and down. The body portion 310 may move up and down along the stay 40. The body portion 310 may move relatively with respect to the stay 40. A movement of the body portion 310 may be accomplished through an electric device provided in the headrest 30. An example of the electric device may include a motor.

The support portion 320 may move up and down. The support portion 320 may move relatively with respect to the body portion 310 up and down. The support portion 320 may slide up and down along the body portion 310. A movement of the support portion 320 may be accomplished through an electric device disposed in the body portion 310 or the support portion 320. An example of the electric device may include a motor.

The support portion 320 may be equipped with a massage device. The outside of the support portion 320 may be wrapped with an outer shell formed of fabric or leather. The massage device 350 may be disposed in the outer shell. Additionally, based on a center in a vertical direction of the support portion 320, the massage device 350 may be disposed below the center in the vertical direction. That is, the massage device 350 may be disposed closer to the passenger's neck than the head.

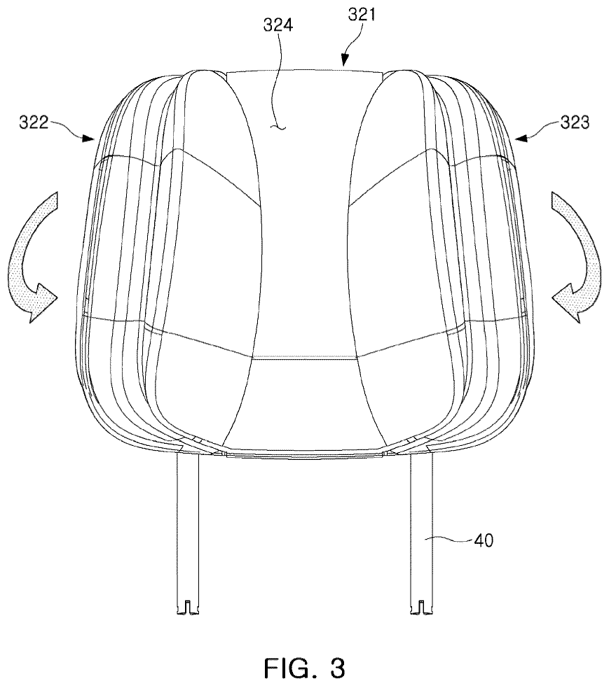

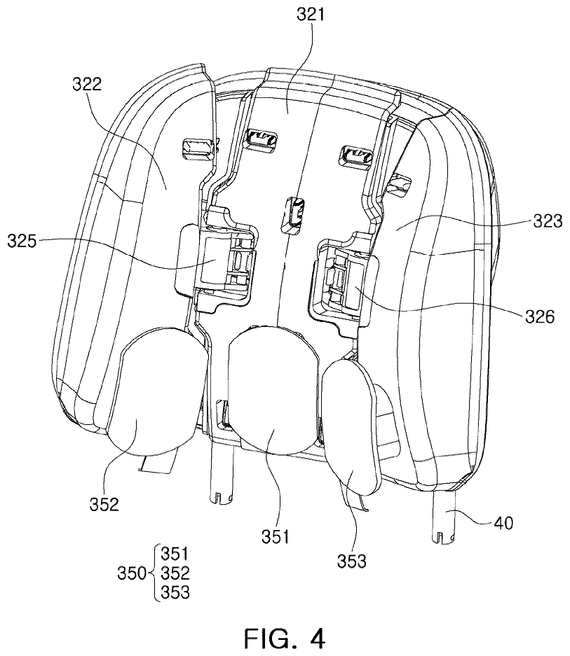

FIG. 3 is a front view of a headrest according to an example embodiment of the present disclosure, and FIG. 4 is a view illustrating a headrest according to an example embodiment of the present disclosure after removing an outer shell thereof.

The headrest 30 may include a center portion 321, a first wing out 322 disposed on one side of the center portion 321, and a second wing out 323 disposed on the other side of the center portion 321.

The first wing out 322 may be hingedly coupled to the center portion 321. The first wing out 322 may rotate using a region hingedly coupled to the center portion 321 as a rotation axis. That is, the first wing out 322 may be tilted by being coupled to the center portion 321. A first electric device 325 for driving the first wing out 322 may be disposed in the center portion 321 or the first wing out 322. An example of the first electric device 325 may include a motor.

The second wing out 323 may be hingedly coupled to the center portion. The second wing out 323 may rotate using the region hingedly coupled to the center portion 321 as a rotation axis. That is, the second wing out 323 may be tilted by being coupled to the center portion 321. A second electric device 326 for driving the second wing out 323 may be disposed in the center portion 321 or the second wing out 323. An example of the second electric device 326 may include a motor.

An accommodation space 324 may be formed between the center portion 321, the first wing out 322, and the second wing out 323. A portion of the passenger's body may be placed in the accommodation space 324. A portion of the body disposed in the receiving space 324 may be, for example, a region of a head and a neck of the passenger.

A size of the accommodation space 324 may vary. Specifically, when the first wing out 322 and the second wing out 323 are tilted and an average separation distance between the first wing out 322 and the second wing out 323 becomes closer, the size of the accommodation space 324 may be reduced. Conversely, when the first wing out 322 and the second wing out 323 are tilted and the average separation distance between the first wing out 322 and the second wing out 323 increases, the size of the accommodation space 324 may be increased.

When the size of the accommodation space 324 is reduced, the first wing out 322 and the second wing out 323 may be close to a portion of the passenger's body. Alternatively, when the size of the accommodation space 324 is reduced, the first wing out 322 and the second wing out 323 may be in close contact with a portion of the passenger's body.

The headrest 30 may be equipped with a massage device 350. The massage device 350 may be disposed in front of the headrest 30. The massage device 350 may be disposed on the support portion 320 of the headrest 30.

The massage device 350 may include air cells 351, 352 and 353. The air cells 351, 352 and 353 may vary in volume. Air may flow into or out of the air cells 351, 352 and 353, and the air cells 351, 352 and 353 may be expanded or be contracted through the inflow or outflow of air.

Although not illustrated, air flow pipes may be connected to the air cells 351, 352 and 353. The air flow pipe may be a means for allowing air to flow into or out of the air cells 351, 352 and 353.

The air flow pipe may be connected to the seating unit 10, the backrest unit 20, or an air supply device (not illustrated) provided in the transportation vehicle. The air supply device may introduce or discharge air into the air cells 351, 352 and 353 through the air flow pipe.

The Air cells 351, 352 and 353 may be arranged in plural form. A first air cell 351 may be disposed in the center portion 321. A second air cell 352 may be disposed in the first wing out 322. A third air cell 353 may be disposed in the second wing out 323. The air cells 351, 352 and 353 may be expanded toward the passenger. The air cells 351, 352 and 353 may massage a portion of the passenger's body by repeating expansion or contraction.

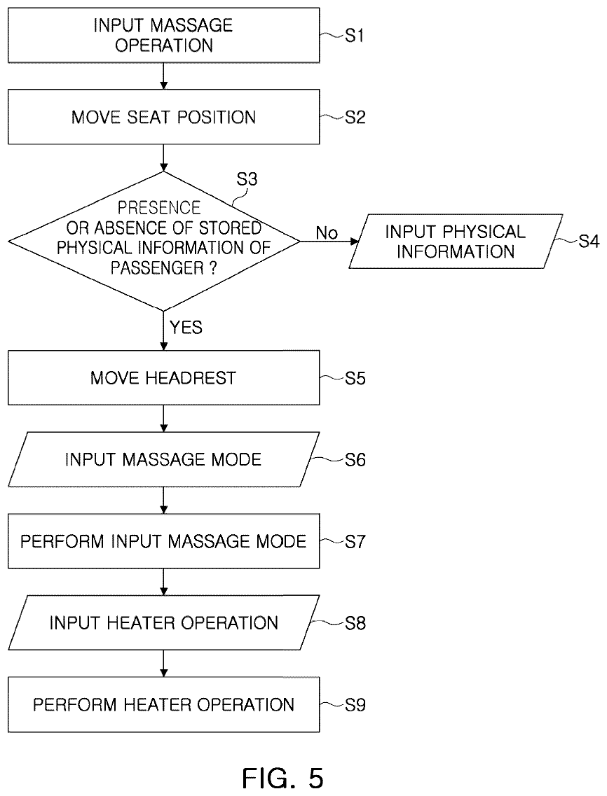

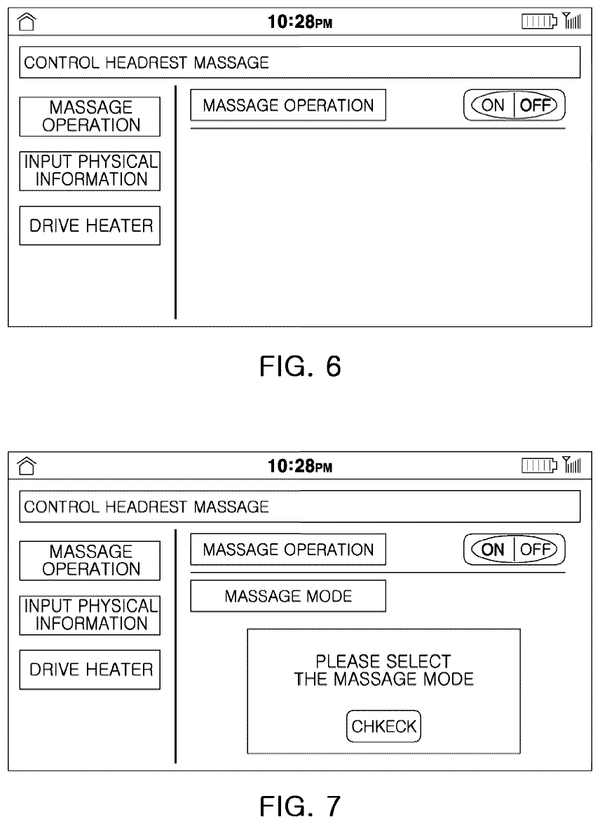

FIG. 5 is a flowchart illustrating an operation of a massage device according to an example embodiment of the present disclosure, and FIGS. 6 to 11 are views illustrating input information and input menus provided through a display of an input device according to an example embodiment of the present disclosure. The display in FIGS. 6 to 11 may be a touch screen, and a user may input a command into the input device by touching a menu on the touch screen.

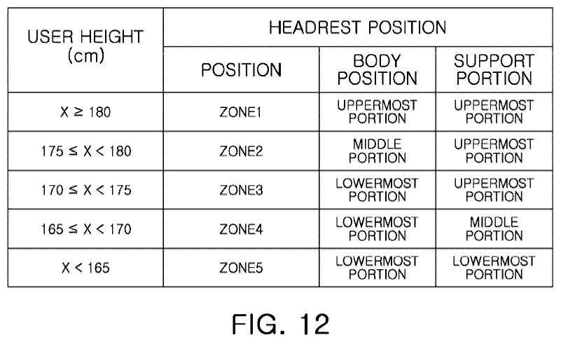

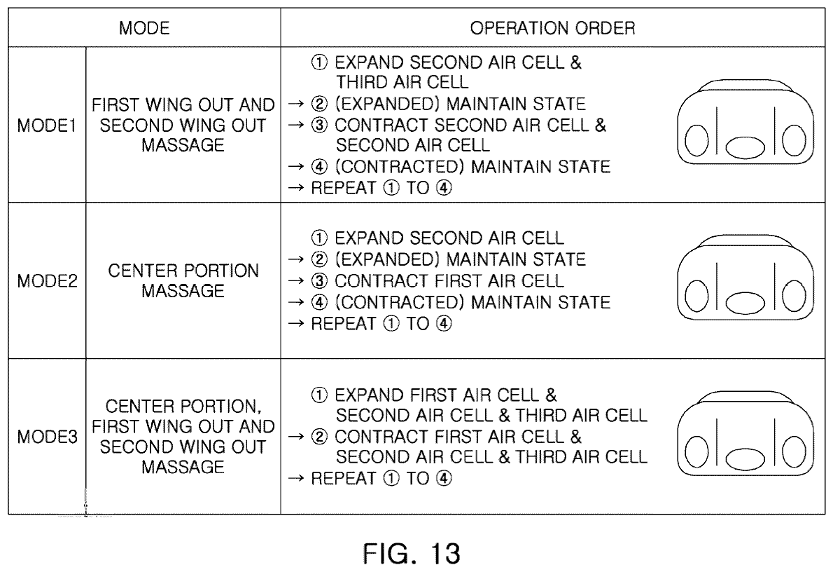

FIG. 12 is a view illustrating a position of a headrest according to body information of a passenger, and FIG. 13 is a view illustrating an operation of an air cell according to a massage mode.

The passenger may select and input a massage operation as illustrated in FIG. 6 through an input device (Operation S1).

When the passenger selects a massage operation, a position of the seat 1 may be moved to a state for a massage (Operation S2). Specifically, the seating portion 10 of the seat 1 may slide in forward and backward directions, and the backrest portion 20 of the seat 1 may be tilted rearward. That is, a distance between the passenger and a steering wheel of the vehicle may be adjusted to increase and an upper body of the passenger may be adjusted to be closer to the ground.

A controller may determine whether physical information of the passenger is stored (Operation S3). Specifically, the physical information of the passenger may be height information. When the height information of the passenger is stored, the controller may move the headrest 30 to a designated position.

FIG. 12 illustrates the position of the headrest 30 according to the height information of the passenger. Referring to FIG. 12, the position of the headrest 30 will be described.

The body portion 310 may move to an uppermost portion, a middle portion, or a lowermost portion. In this case, the uppermost portion may denote a position in which the body unit 310 disposed above the backrest unit 20 moves most upward along the stay 40. The lowermost portion may denote a position in which the body portion 310 disposed above the backrest unit 20 moves to a lowermost side along the stay 40. Additionally, the middle portion may denote a position between the uppermost portions and the lowermost portion.

The support portion 320 may move to an uppermost portion, a middle portion, or a lowermost portion. In this case, the uppermost portion may denote a position in which the support portion 320 slides most upward along the body unit 310. The lowermost portion may denote a position in which the support portion 320 slides in a lowermost direction along the body unit 310. Additionally, the middle portion may denote a position between the uppermost portion and the lowermost portion.

If the passenger's height is 180 cm or more, the headrest 30 moves to a first position (zone 1). In the first position, the body portion 310 moves to the uppermost portion and the support portion 320 moves to the uppermost portion.

If the passenger's height is 175 cm or more and less than 180 m, the headrest 30 moves to a second position (zone 2). In the second position, the body portion 310 moves to the middle portion and the support portion 320 moves to the uppermost portion.

If the passenger's height is more than 170 cm and less than 175 m, the headrest 30 moves to a third position (zone 3). In the third position, the body portion 310 moves to the lowermost portion and the support portion 320 moves to the uppermost portion.

If the passenger's height is 165 cm or more and less than 170 m, the headrest 30 moves to a fourth position (zone4). In the fourth position, the body portion 310 moves to the lowermost portion and the support portion 320 moves to the middle portion.

If the passenger's height is less than 160 cm, the headrest 30 moves to a fifth position (zone 5). In the fifth position, the body portion 310 moves to the lowermost position and the support portion 320 moves to the lowermost position.

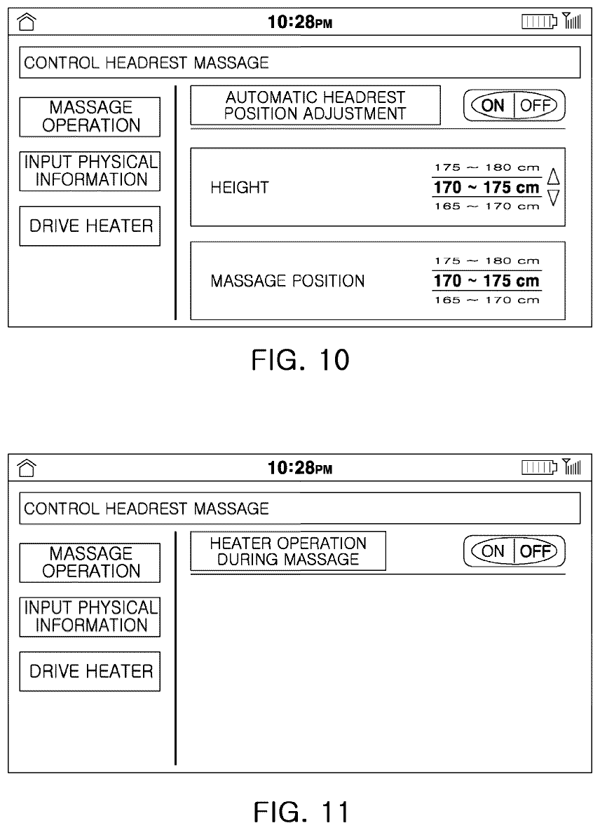

The controller may determine whether the physical information of the passenger is stored (Operation S3). When there is no stored physical information (height information) of the passenger, the controller may request the passenger to input physical information. FIGS. 9 and 10 illustrate an input device menu requesting the passenger to input body information.

The passenger may input height information through the input device (Operation S4). The controller may move the headrest 30 to a determined position based on height information input by the passenger (Operation S5). In this case, the determined position may be the first to fifth positions described above with reference to FIG. 12.

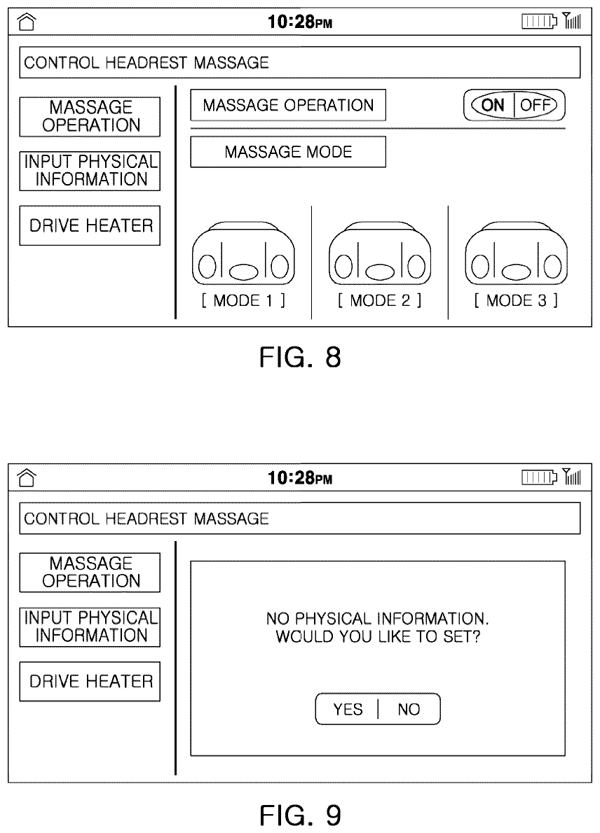

When the headrest moves based on height information, the passenger may input a massage mode through the input device (Operation S6). FIGS. 7 and 8 are views illustrating a menu for selecting the massage mode on the input device. The passenger may select and input the massage mode from first to third modes.

When the passenger selects the massage mode, the controller may perform a massage operation according to the input massage mode (Operation S7). FIG. 13 is a view illustrating an operation of the massage mode that a passenger may input through an input device.

The first massage mode (mode 1) performs a massage operation using the second air cell 352 and the third air cell 353. The first air cell 351 disposed in the center portion 321 may not be expanded. The second air cell 352 disposed in the first wing out 322 and the third air cell 353 disposed in the second wing out 323 may repeat expansion and contraction.

Specifically, after the second air cell 352 and the third air cell 353 are expanded, an expanded state may be maintained for a certain period of time. In this case, the certain period of time may be a preset time.

Then, the second air cell 352 and the third air cell 353 may be contracted and then maintained in a contracted state for a certain period of time. In this case, the certain period of time may be a preset time.

When the passenger does not change the massage mode or terminate the massage mode, expansion and contraction of the second air cell and the third air cell as described above may be performed repeatedly. However, even if the passenger does not change the massage mode or terminate the massage mode, when the time input to the controller elapses, the massage mode may terminate.

The second massage mode (mode 2) performs a massage operation using the first air cell 351. The second air cell 352 disposed in the first wing out 322 and the third air cell 353 disposed in the second wing out 323 may not be expanded. The first air cell 351 disposed in the center portion 321 may repeat expansion and contraction.

Specifically, after the first air cell 351 is expanded, an expanded state may be maintained for a certain period of time. In this case, the certain period of time may be a preset time.

Then, the first air cell 351 may be contracted and then maintained in a contracted state for a certain period of time. In this case, the certain period of time may be a preset time.

When the passenger does not change the massage mode or terminate the massage mode, expansion and contraction of the first air cell 351 as described above may be performed repeatedly.

The third massage mode (mode 3) performs a massage operation using the first air cell 351, the second air cell 352, and the third air cell 353. The first air cell 351 disposed in the center portion 321, the second air cell 352 disposed in the first wing out 322, and the third air cell 353 disposed in the second wing out 323 may repeat expansion and contraction.

Specifically, after the first air cell 351, the second air cell 352, and the third air cell 353 are expanded, an expanded state may be maintained for a certain period of time. In this case, the certain period of time may be a preset time.

Then, after the first air cell 351, the second air cell 352, and the third air cell 353 are contracted, a contracted state may be maintained for a certain period of time. In this case, the certain period of time may be a preset time.

When the passenger does not change the massage mode or terminate the massage mode, expansion and contraction of the first air cell 351, second air cell 352, and third air cell 353 as described above may be performed repeatedly.

While the massage mode is performed, the passenger may input whether or not a heater should operate (S8).

The headrest 30 may include a heater. The heater may be a heater using a heating wire. In this case, the heating wire may be disposed inside an outer shell of the headrest 30. The heater may operate through heating of the heating wire, and the heater may transfer heat to the passenger. The heater may operate in conjunction with the operation of the massage device.

The seat according to an example embodiment of the present disclosure has the effect of reducing fatigue felt by passengers of a transportation means. Specifically, the body portion 310 and the support portion 320 of the headrest 30 may be moved according to the height information of the passenger, so that the air cells 351, 352 and 353 of the massage device 350 may be disposed close to the passenger's neck, through which the air cells 351, 352 and 353 may effectively massage the passenger's neck. The massage device may effectively relax neck muscles of the passenger operating the transportation vehicle by massaging the neck muscles, thereby reducing passenger fatigue.

While example embodiments have been illustrated and described above, it will be apparent to those skilled in the art that modifications and variations could be made within a scope not departing from the spirit and region of the present disclosure as defined by the appended claims.

What is claimed is:

1. A seat for a vehicle, the seat comprising:
an input device configured to receive input information including height information of a passenger;
a backrest unit configured to support a back of the passenger; and
a headrest disposed above the backrest unit,
wherein the headrest comprises a massage device configured to massage a portion of a body of the passenger, and the massage device is configured to change position depending on height information of the passenger input to the input device.

2. The seat according to claim 1, wherein the headrest comprises:
a body portion; and
a support portion,
wherein the massage device is disposed in the support portion.

3. The seat according to claim 2, wherein the support portion is disposed in front of the body portion and slidingly movable in a vertical direction of the body portion along the body portion.

4. The seat according to claim 3, wherein the body portion is provided to be movable in the vertical direction relative to the backrest unit.

5. The seat according to claim 3, wherein the support portion is configured to move to an uppermost portion in an upper direction of the body portion, a lowermost portion in a downward direction of the body portion, or a middle portion disposed between the uppermost portion and the lowermost portion, according to the height information of the passenger.

6. The seat according to claim 3, wherein the body portion is configured to move to an uppermost portion in an upward direction of the backrest unit, a lowermost portion in a downward direction of the backrest unit, or a middle portion disposed between the uppermost portion and the lowermost portion.

7. The seat according to claim 1, wherein the massage device comprises at least one air cell disposed on the headrest.

8. The seat according to claim 1, wherein the massage device comprises:
first to third air cells disposed on the headrest,
wherein the first air cell is disposed between the second air cell and the third air cell.

9. The seat according to claim 8, wherein the headrest comprises:
a center portion;
a first wing out disposed on one side of the center portion; and
a second wing out disposed on another side of the center portion.

10. The seat according to claim 9, wherein:
the first air cell is disposed in the center portion,
the second air cell is disposed in the first wing out, and
the third air cell is disposed in the second wing out.

11. The seat according to claim 6, wherein the input device is configured to enable the passenger to select one of a plurality of massage modes.

12. The seat according to claim 11, wherein a first massage mode of the plurality of massage modes includes an operation of expanding or contracting the second air cell and the third air cell.

13. The seat according to claim 11, wherein a second massage mode of the plurality of massage modes includes an operation of expanding or contracting the first air cell.

14. The seat according to claim 11, wherein a third massage mode of the plurality of massage modes includes an operation of expanding or contracting the first air cell, the second air cell, and the third air cell.

15. A vehicle comprising the seat of claim 1.

16. A seat for a vehicle, the seat comprising:
a seating unit on which a passenger is seated;
a backrest unit configured to support a back of the passenger;
a headrest disposed above the backrest unit; and
a massage device disposed in the headrest,
wherein the headrest is configured to change position depending on height information of the passenger.

17. The seat according to claim 16, further comprising an input device configured to receive input information including the height information of the passenger.

18. The seat according to claim 16, wherein the headrest comprises:
a body portion; and
a support portion,
wherein the massage device is disposed on the support portion.

19. The seat according to claim 18, wherein the support portion is disposed in front of the body portion and slidingly movable in a vertical direction of the body portion along the body portion.

20. The seat according to claim 16, wherein the massage device comprises at least one air cell disposed on the headrest.
